(19) United States
(12) Patent Application Publication
(10) Pub. No.: US 2006/0220374 A1
(43) Pub. Date: Oct. 5, 2006

(54) Chart including waypoints and corresponding directional symbols

(75) Inventors: Jonathan A. Dorn, Emmaus, PA (US); Jay A. Heinrichs, Orange, NH (US); Marc E. Kauffman, Slatington, PA (US)

Correspondence Address: SUGHRUE MION, PLLC, 2100 PENNSYLVANIA AVENUE, N.W., SUITE 800, WASHINGTON, DC, 20037, US

(73) Assignee: Backpacker Magazine

(21) Appl. No.: 11/097,255

(22) Filed: Apr. 4, 2005

(51) Int. Cl. B42D 15/00

(52) U.S. Cl. 283/115

(57) ABSTRACT

A multiple card configuration includes directional instructions on a sheet having a front side and a back side. Multiple charts are provided on the front side to respectively represent different predetermined routes and are separated by perforations so that the charts are selectively removable from the sheet. The charts include multiple reference points which are sequentially listed and distance indicators which represent a distance from a beginning of the routes to the reference points. Waypoints are also included that provide a global position of the reference points, along with symbols which correspond to the reference points and which inform a user which direction to proceed from one of the waypoints to another one of the waypoints. The multiple card configuration may be a printed publication, such as a magazine, where the perforations completely surround a plurality of the charts.

### FIELD OF THE INVENTION

Apparatuses consistent with the present invention relate to predetermined directional information listed on a document and, more particularly, relate to a chart and map used for guiding a backpacker through a geographical region using waypoints and directional symbols.

### BACKGROUND OF THE INVENTION

Interest in hiking and backpacking throughout regions of the world has increased each year. With the rise in wilderness exploration, outdoor enthusiasts have been recently using advanced navigational tools. One such tool is a Global Positioning System (GPS), which is a satellite-based navigational system made up of a network of satellites placed into orbit by the U.S. Department of Defense. The GPS was originally intended for military applications, but in the 1980's, the U.S. Government made the system available for civilian use. Personal GPS receivers typically work in most weather conditions and in all areas of world.

GPS satellites circle the earth in a precise orbit while transmitting signal information to the earth. A user's handheld GPS receiver takes this information and uses triangulation to calculate the user's location on earth. This allows for a backpacker or hiker to determine their geographical location with precision.

A known technique of navigating an outdoor area with a GPS receiver includes determining one's position based on longitude and latitude coordinates provided by the GPS, in combination with a topographical map that represents the longitude and latitude coordinates. A distinctive characteristic of a topographical map is that the shape of the earth's surface is shown by contour lines. Contour lines are imaginary lines that join points of equal elevation on a surface of the land, above or below a reference surface, such as sea level. Contour lines also make it possible to measure the height of a mountain, depth of an ocean and steepness of a slope.

Although the use of a GPS receiver along with a topographic map allows for one to determine their location, a user is confronted with the time consuming task of plotting out a predetermined route on a topographical map and then programming a handheld GPS receiver to include the desired points along the route. Pre-made trail guides are available; however, they are often part of large book including information pertaining to many different potential hiking trails, which is cumbersome to carry and adds unnecessary weight. Further, pre-made trail guides often include only a minimal amount of directional information, which may be insufficient for precise navigation depending on trail conditions and fluctuations in weather.

### SUMMARY OF THE INVENTION

Illustrative, non-limiting embodiments of the present invention overcome the disadvantages described above and other disadvantages. Also, the present invention is not required to overcome the disadvantages described above and the other disadvantages, and an illustrative, non-limiting embodiment of the present invention may not overcome any of the disadvantages.

An aspect of the present invention is to provide a user with a predetermined route that includes waypoints corresponding to geographical regions, in combination with directional symbols. It is another aspect of the present invention to provide a mechanism for distributing multiple maps via a page of a publication, such that a user can easily remove desired directional information from the page.

In accordance with an exemplary embodiment, a multiple card configuration is provided including directional instructions on a sheet having a front side and a back side. Multiple charts are provided on the front side to respectively represent different predetermined routes and are separated by perforations so that the charts are selectively removable from the sheet.

It is contemplated that the charts include multiple reference points which are sequentially listed, along with distance indicators which represent a distance from a beginning of the respective routes to the reference points. Waypoints are also included to provide a global position of the reference points, along with symbols that correspond to the reference points and inform a user which direction to proceed from one of the waypoints to another one of the waypoints. The multiple card configuration may be provided in a printed publication, such as a magazine where the perforations surround individual charts so that the charts can be separately removed. The perforations may extend in horizontal and vertical directions and interest each other. In an exemplary embodiment, the perforations extend in the vertical direction from a top border of the charts, in a top row, to a bottom edge of the sheet, and across the full width of the sheet in the horizontal direction.

It is further contemplated that the multiple card configuration includes a plurality of topographical maps representing different geographical areas that correspond to the predetermined routes and are provided on the back side of the sheet, such that when one of the charts is removed, a corresponding one of the topographical maps is removed and located behind the removed chart. The topographical maps may also include segment markers which depict where the waypoints of a corresponding one of the charts are located in the geographical areas.

In accordance with a further exemplary embodiment of the present invention, provided is a document including geographical instructions pertaining to a route, comprising a sheet having a front portion and a back portion. A chart is provided on the front portion and represents a predetermined route. The chart includes multiple reference points which are sequentially listed; distance indicators which represent a distance from a beginning of the route to the reference points; waypoints which provide a global position of the reference points; and symbols which correspond to the reference points and which inform a user which direction to proceed from one of the waypoints to another one of the waypoints. It is further contemplated that a topographical map, representing a geographical area of the route, is provided on the back portion of the sheet to include segment markers which depict where the waypoints are located in the geographical area.

### BRIEF DESCRIPTION OF THE DRAWINGS

Other aspects of the invention will become apparent from the detailed description of exemplary embodiments which follow, when considered in light of the accompanying drawings, in which:

FIG. 1 is a plan view of an exemplary embodiment of the invention showing multiple charts provided on a single sheet;

FIG. 2 is a back view of the embodiment in FIG. 1, including topographical representations of geographic regions;

FIG. 3 is an enlarged view of a further exemplary embodiment of the invention, including a single chart having directional information; and

FIG. 4 is a rear view of the chart in FIG. 3, showing a topographical map.

### DETAILED DESCRIPTION OF EXEMPLARY, NON-LIMITING EMBODIMENTS

The following description of illustrative, non-limiting embodiments of the invention discloses specific configurations, components, processes and operations. However, the embodiments are merely examples of the present invention and, thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, components, processes and operations of the embodiments that are known to one skilled in the art are omitted for the sake of clarity and brevity.

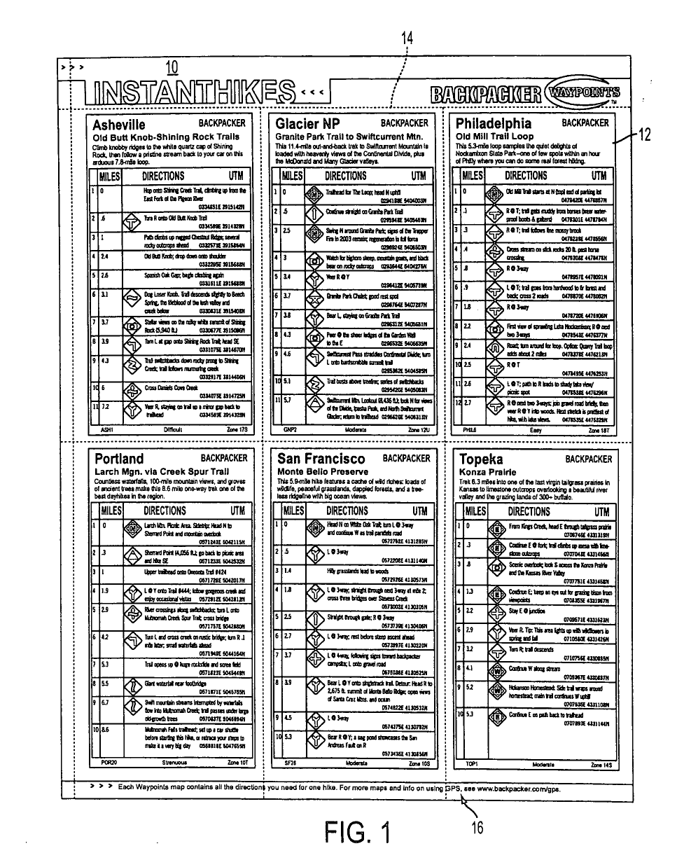

A multiple card configuration of the present invention provides a user with a predetermined route including navigational information. The card configuration can also be distributed in a manner that is effective for mass distribution and convenient for a user to obtain. FIG. 1 illustrates a front view of a sheet 10 including multiple charts 12, in accordance with an exemplary embodiment of the invention. The charts 12 are provided in rows and respectively provide route information for different geographical areas of the world, as is discussed below in more detail. The charts 12 are boarded by a perforated line which separates the charts 12 from each other. A perforated line may not be necessary if a particular chart 12 is directly bordered by an edge of the sheet 10. In an exemplary embodiment, two rows are provided with three charts in each row. This results with the charts 12 being sized to easily fit within a pocket or a user's garment or backpack. It will be appreciated, however, that a different number of charts 12 can be provided. In an exemplary embodiment, the individual charts 12 are sized in the range of 6 cm wide by 13 cm high, and more particularly, 6.3 cm wide by 12.7 cm high. Other exemplary ranges may also be used, such as 6 cm wide by 25.5 cm high; 13 cm wide by 13 cm high; 10 cm wide by 13 cm high; and 20 cm wide by 13 cm high. As will be appreciated, these sizes are exemplary and may be altered for particular design requirements or a user's need.

The perforations 14 permit a user to easily remove any of the individual charts 12, while maintaining a predetermined and defined shape of the charts 12. The perforations 14 may be in the form of a series of holes punched or bored through the sheet 10. Instead of a series of holes, the sheet 10 may also be scored around the border of the charts 12. The perforations 14 may extend in horizontal and vertical directions and interest each other. In an exemplary embodiment, the perforations 14 extend in the vertical direction from a top border of the charts 12, in the top row, to the bottom edge of the sheet 10, and across the full width of the sheet 10 in the horizontal direction. However, other configurations of perforations 14 can be provided depending on the layout of the charts 12.

In an exemplary embodiment, the sheet 10 and charts 12 may be constructed of a material that is water resistant, such as coated card stock (paper) having ultraviolet protection (UV), which may have 100% UV protection. Other exemplary materials may also be used, such as waterproof or water resistant, tear-resistant plastic papers known as YUPO and POLYART. These materials are exemplary and may be altered to include stock having different weights, such as a heavy card stock, other waterproof plastic-based sheets, laminated cards, or the like. It is also contemplated that the charts 12 may be provided on postcards. The total sheet 10 may be made of such water resistant or water proof materials, or only the charts 12 themselves may include such material, so that the remaining portions of the sheet are made of a standard material used in a publication.

The sheet 10 on which the charts 12 are provided, may be included in a printed publication directed to outdoor enthusiasts, such as BACKPACKER® magazine. The sheet 10 would be bound with other pages of the publication and may be the same size as the adjoining pages. Therefore, a publisher is able to include the sheet 10 having the charts 12 in the publication so that the charts 12 are widely dispersed and easily accessible by a user. As shown in FIG. 1, website information 16 may also be provided on the sheet 10 to inform the user where to find further details regarding the charts 12 and use thereof.

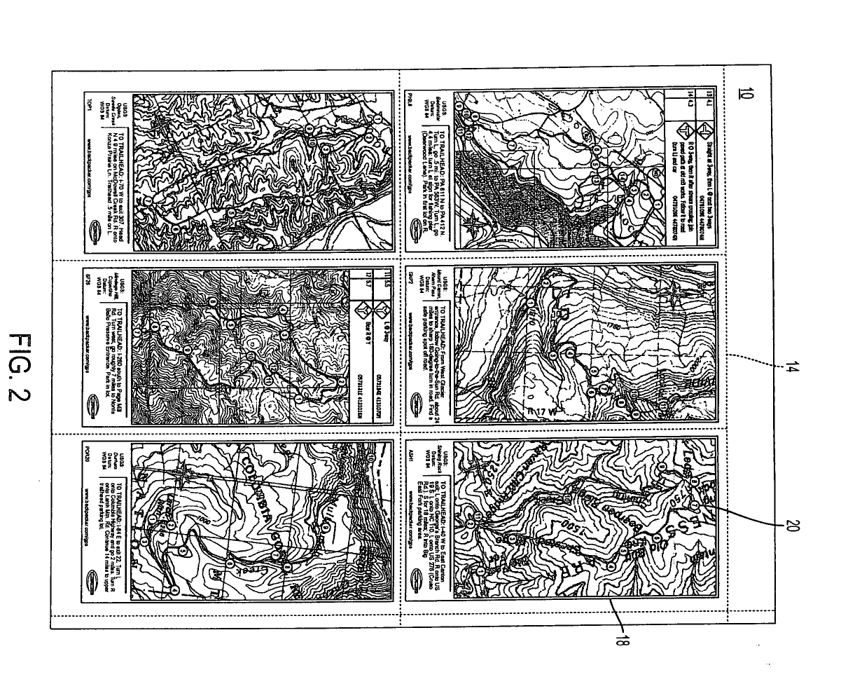

FIG. 2 shows a backside of the sheet 10 in FIG. 1. The backside includes multiple topographical maps 18 which correspond to the routes provided on the front of the sheet 10. Therefore, when a user removes a respective chart 12 from the sheet 10, they are provided with route information on one side and a topographical map 18 on the other side. As is also shown in FIG. 2, the respective maps include numbered locations corresponding to points of the route.

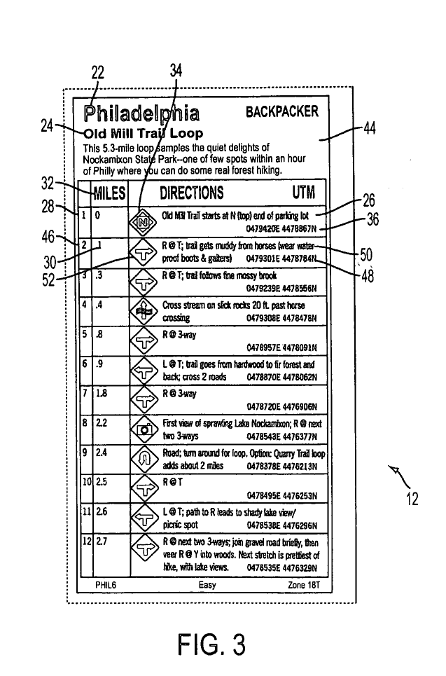

FIG. 3 shows a chart 12 which has been removed from the sheet 10. As will be appreciated, the chart 12 provides a beneficial combination of data, including directional information that allows a user to effectively navigate along a predetermined route. In an exemplary embodiment, the chart 12 includes a title 22 noting a general geographical area in which the route is provided. A commonly used name 24 of the route can also be provided to further familiarize the user with the area, such as the “Old Mill Trail Loop,” shown in FIG. 3. A brief summary 26 of the route may further be provided so that the user can quickly access the length of the route, along with its highlighted features to determine whether the particular route is suitable for the user.

In the exemplary embodiment of FIG. 3, the route information is broken up into reference points 28, which are sequentially labeled in, for example, the left-hand column. The second to left column includes an indication of distance 30 from the start of the route to each point along the route, as shown in the “MILES” column 32. Accordingly, a user is able to effectively determine the amount of distance between the respective points 28 along the route. As one skilled in the art would appreciate, this feature adds to the navigational benefits of the chart 12 when used in combination with a GPS that displays an amount of distance traveled. Therefore, a user is able to easily determine what reference point 28 of the route she is on.

Brief summaries 26 of the reference points 28 are provided. For example, the first reference point 28 is described in the summary 26 as being the start of the trail or trailhead, and is also described as being at the “end of the parking lot.” The summaries 26 are also respectively provided for the other reference points 28 (i.e., points 1-12) and may include information pertaining to attributes of the trail, including potential views, an overall condition of the trail, a commonly used name of the reference point (e.g., Swiftcurrent Glacier), a point of interest, or the like.

In accordance with another exemplary aspect of the invention, symbols 34 are provided that respectively correspond to the various reference points 28 and provide the user with a quick and effective means of directional information. For example, as shown at point “2” in FIG. 3, the symbol 34 is in the form of a yield sign containing an arrow pointing in the right direction. As will be appreciated, backpackers are often confronted with adverse weather conditions and poor lighting that hinder the user's ability to effectively perceive directional instructions. The aspects of the present invention allow a user to easily look at their hand-held instructions to quickly determine their next directional move based on the provided symbols 34. The symbols 34 may also represent areas where a user desires to take a picture, thus allowing for the user to prepare their film or camera. The symbols 34 may further represent various obstacles, such as stream crossings or switchback paths, which further provide the user with beneficial knowledge regarding the route or trail so that proper measures can be taken.

The chart 12 also includes waypoints 36 that respectively correspond to the various reference points 28 of the chart 12. The waypoints 36 are fixed locations within a specified area of the earth and can be used to mark a destination, a point along the way to a destination or a basic point of reference. The waypoints 36 may be represented by longitude and latitude in the form of degrees, hours and minutes, or may be indicated by Universal Transverse Mercator (UTM) coordinates that use a decimal-based metric system to number the coordinates. The exemplary embodiment of FIG. 3 provides UTM coordinates. Using the information provided on the chart 12, a user is able to effectively navigate through a predetermined route while using a GPS receiver. The combination of the various forms of information provided on the chart 12 contributes to helping the user effectively navigate the route.

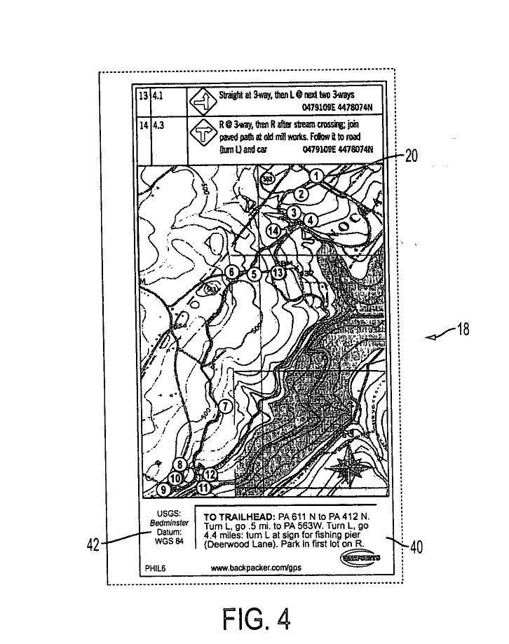

As shown in FIG. 4, the backside of the chart 12 includes the topographical map 18 representation of the predetermined route. Included on the map 18 are the numbered locations 20, which correspond to the reference points 28 and the waypoints 36 represented by the UTM coordinates. In general, the UTM coordinates act as a reference grid corresponding to the topographical map 18 that divide terrain into standardized areas. Each line of the grid represents an east/west or north/south position, similar to longitude and latitude. This allows a user to quickly and easily determine their geographical location on the topographical map 18 by comparing their present position with the numbered locations 20 of the topographical map 18. To even further aid the user, directions 40 to the trailhead and Datum information 42 may be provided.

In use, with reference to FIG. 1 and FIG. 2, a user selectively removes a desired chart 12 and the corresponding backside map 18 from the sheet 10 corresponding to the predetermined route that she wishes to travel. This is done by applying a moderate amount of pressure of the chart 12 so that a shear stress is created along the perforation 14 causing the chart 12 to cleanly separate from the sheet 10 along the perforation. The chart 12 having the map 18 is then easily stored in the user's pocket and, because of its size, folding of the chart 12 is not necessary, as is often required with larger charts and maps.

The user then follows the directions 40 to arrive at the starting point or trailhead. The directions 40 to the trailhead may be provided in the form of road and highway routes to allow the user to navigate their vehicle to the trailhead using a road map of the general area.

Upon reaching the trailhead, the user may desire to reset a distance indicator on the GPS receiver to zero. This will allow the user to determine their progress along the route based on the distance traveled. As will be appreciated, during foul weather, a GPS receiver may temporarily lose a signal resulting in an inaccurate reading in mileage. However, the user is able to effectively navigate to the reference points 28 of the route based on the waypoints 36, symbols 34 and trail descriptions 26.

As the user begins to navigate the trail, she may desire to look at the symbol 34 provided for the start point. In the illustrative embodiment of FIG. 3, the first symbol 34 represents an “N” informing the user to proceed in the north direction. The first reference point 28 is also accompanied by the description 26 indicating that the trail starts at the end of the parking lot, which further aids the user. In addition, the waypoint 36 represented by the UTM coordinates can also be used to locate the trailhead. The user may desire to pre-program all of the listed waypoints 36 in the GPS receiver before starting the route. Because the waypoints 36 are predetermined and provided on the chart 12, the user can program the GPS receiver well in advance.

After the user proceeds in the north direction, in the exemplary embodiment, various pieces of information provided in the chart 12 may be additionally utilized. These include the distance 30 to the second reference point 46, the waypoint 48 of the second reference point 46, in addition to the brief narrative 50 corresponding to the second reference point 46. As shown in the narrative 50 of the second reference point 46, an indication is given that the trail becomes muddy from horses and suggests that waterproof boots and gators be worn. Therefore, users are able to equip themselves with the proper gear before entering this section of the route. After the user reaches the second reference point 46, she may utilize the directional symbol 52 that indicates which direction to proceed. As shown in regard to the second reference point 46, the directional symbol 52 indicates that the user will want to turn right at the trail.

Using the manner described above, the user is able to effectively navigate through the remainder of the trail, while possessing advance knowledge of the various points of interest along the route and having the benefit of knowing what to expect upon arriving at the reference points. The exemplary embodiment of FIG. 3 shows 12 reference points. However, it will be appreciated that this number may vary depending upon the length of the trail and its characteristics.

In addition to the information provided in the chart 12, the user is able to easily access the topographical map 18 to accurately determine their geographical location. The topographical map 18 allows the user to determine the environmental characteristics of the user's present position and what lay ahead of them. For example, a user traveling from point 3 to point 4 is able to observe the contour lines of the map 18 to determine a change in elevation and whether a steep incline or decent will be encountered. The topographical map 18 also provides an overall picture of the area, including bodies of water and roads to make the user's experience more enjoyable and help ensure that the predetermined route is not strayed from.

Exemplary embodiments of the invention have been described in regard to hiking and backpacking maps. It will be appreciated, however, that the invention can also be used to provide route guidance for other modes of travel, such as when traveling in an automobile, boat, and the like.

The previous description of the exemplary embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein, but is to be accorded the widest scope as defined by the limitations of the claims and equivalents thereof.

What is claimed is:

1. A multiple card configuration including directional instructions, comprising:
a sheet having a front side and a back side; and
multiple charts provided on said front side, said charts respectively representing different predetermined routes and are separated by perforations so that said charts are selectively removable from said sheet.

2. The multiple card configuration of claim 1, wherein said charts comprise:
multiple reference points which are sequentially listed;
distance indicators which represent a distance from a beginning of said routes to said reference points;
waypoints which provide a global position of said reference points; and
symbols which correspond to said reference points and which inform a user which direction to proceed from one of said waypoints to another one of said waypoints.

3. The multiple card configuration of claim 1, wherein said sheet is a page of a printed publication.

4. The multiple card configuration of claim 3, wherein said publication is a magazine.

5. The multiple card configuration of claim 1, wherein said perforations surround said charts individually so that said charts can be separately removed.

6. The multiple card configuration of claim 2, wherein multiple topographical maps of geographical areas corresponding to said predetermined routes are provided on said back side of said sheet, such that when one of said charts is removed, a corresponding one of said topographical maps is removed and located behind said chart which is removed.

7. The multiple card configuration of claim 6, wherein said topographical maps include segment markers which depict where said waypoints of a corresponding one of said charts are located in said geographical areas.

8. The multiple card configuration of claim 2, wherein said charts respectively include an indication of difficulty.

9. The multiple card configuration of claim 2, wherein said back side includes directions to trailheads of said routes.

10. The multiple card configuration of claim 2, wherein said waypoints are in the form of Universal Transverse Mercator (UTM) coordinates.

11. The multiple card configuration of claim 2, wherein said waypoints are in the form of longitudinal and latitude coordinates.

12. The multiple card configuration of claim 1, wherein said sheet is made of a water resistant coated card stock having ultraviolet protection.

13. The multiple card configuration of claim 1, wherein said charts, after being removed, have a width in a range of 6 cm to 20 cm and a height in a range of 12.7 cm to 25.5 cm.

14. The multiple card configuration of claim 2, wherein said symbols are in a shape of a road sign and include a directional marker.

15. The multiple card configuration of claim 2, wherein said symbols are in a shape of a road sign and include a representation of a corresponding one of said reference points.

16. The multiple card configuration of claim 10, wherein said Universal Transverse Mercator (UTM) coordinates include a zone.

17. The multiple card configuration of claim 1, wherein said routes represent different hiking routes.

18. A document including geographical instructions pertaining to a route, comprising:
a sheet having a front portion and a back portion;
a chart provided on said front portion and representing a predetermined route, said chart comprising,
multiple reference points which are sequentially listed;
distance indicators which represent a distance from a beginning of said route to said reference points;
waypoints which provide a global position of said reference points; and
symbols which correspond to said reference points and which inform a user which direction to proceed from one of said waypoints to another one of said waypoints.

19. The document of claim 18, wherein a topographical map representing a geographical area of said route is provided on said back portion of said sheet.

20. The document of claim 19, wherein said topographical map includes segment markers which depict where said waypoints are located in said geographical area.

21. The document of claim 18, wherein said chart includes an indication of difficulty.

22. The document of claim 18, wherein said back portion includes directions to a trailhead of said route.

23. The document of claim 18, wherein said waypoints are in the form of Universal Transverse Mercator (UTM) coordinates.

24. The document of claim 18, wherein said waypoints are in the form of longitudinal and latitude coordinates.

25. The document of claim 18, wherein said sheet is made of a water resistant coated card stock having ultraviolet protection.

26. The document of claim 18, wherein said chart has a width in a range of 6 cm to 20 cm and a height in a range of 12.7 cm to 25.5 cm.

27. The document of claim 18, wherein said symbols are in a shape of a road sign and include a directional marker.

28. The document of claim 18, wherein said symbols are in a shape of a road sign and include a representation of a corresponding one of said reference points.

29. The document of claim 23, wherein said Universal Transverse Mercator (UTM) coordinates include a zone.

30. The document of claim 18, wherein said route represents a hiking route.

31. The document of claim 18, wherein said chart is part of a page in a printed publication and is removable from said page by separating said chart from said page along a perforated area which forms an edge of said chart.

32. A multiple card configuration including directional instructions, comprising:
a sheet having a front side and a back side;
multiple charts provided on said front portion, said charts respectively representing different predetermined hiking routes and are separated by perforations so that said charts are selectively removable from said sheet, said charts comprising,
multiple reference points which are sequentially listed;
distance indicators which represent a distance from a beginning of said routes to said reference points;
waypoints which provide a global position of said reference points; and
symbols which correspond to said reference points and which inform a user which direction to proceed from one of said waypoints to another one of said waypoints,
wherein multiple topographical maps representing different geographical areas corresponding to said predetermined hiking routes are provided on said back side of said sheet, such that when one of said charts is removed, a corresponding one of said topographical maps is removed and located behind said chart which is removed, and
wherein said topographical maps include segment markers which depict where said waypoints are located in said geographical areas.
